(19) United States
(12) Patent Application Publication
(10) Pub. No.: US 2010/0017534 A1
(43) Pub. Date: Jan. 21, 2010

(54) SYSTEM AND METHOD FOR REAL-TIME QUESTION AND ANSWER SESSIONS VIA A GLOBAL COMPUTER NETWORK

(76) Inventor: Shrage Smilowitz, Monroe, NY (US)

Correspondence Address: MALDJIAN & FALLON LLC, 365 BROAD STREET, THIRD FLOOR, RED BANK, NJ, 07701, US

(21) Appl. No.: 12/504,747

(22) Filed: Jul. 17, 2009

Related U.S. Application Data
(60) Provisional application No. 61/081,528, filed on Jul. 17, 2008.

(51) Int. Cl. G06F 15/16

(52) U.S. Cl. 709/231

(57) ABSTRACT

Embodiments of the present invention relate to a system of and method for executing a real-time, interactive question-and-answer session broadcast to users via a global computer network. In one embodiment, a method of providing real-time question and answer sessions via a global computer network comprises providing a network-accessible data portal hosted on a central server, accessible to a plurality of clients in a global computer network; receiving at the central server, a multimedia data stream from a broadcast host; displaying the multimedia data stream to a plurality of clients, including at least a first client, via the network-accessible data portal; receiving responsive data from the first client; and presenting the responsive data to the broadcast host; wherein the multimedia data stream is presented to the plurality of clients in real-time.

### CROSS-REFERENCE TO RELATED APPLICATIONS

This application claims the benefit of U.S. Provisional Patent Application Ser. No. 61/081,528, filed Jul. 17, 2009, the disclosure of which is incorporated herein by reference in their entireties.

### BACKGROUND

1. Field of the Invention

Embodiments of the present invention generally relate to a real-time question-and-answer session. More specifically, embodiments of the present invention relate to a system of and method for executing a real-time, interactive question-and-answer session broadcast to users via a global computer network.

2. Description of Related Art

There are numerous ways to obtain information from the Internet regarding a particular subject, computer software package or the like. For example, a simple search in a search engine will often yield thousands of results pertaining to a selected topic. However, more often than not, the specific information needed is nowhere to be found on any of the located results.

Some search engines have added specific “question” sections, whereby other users may review the submitted question and provide an answer thereto. Unfortunately, there is no way to verify such information, and waiting for an accurate answer may take a significant number of days, weeks or months, if an answer is ever provided.

Therefore, there is a need for a system and method for a real-time question-and-answer session via a global computer network.

### SUMMARY

Embodiments of the present invention generally relate to a real-time question-and-answer session. More specifically, embodiments of the present invention relate to a system of and method for executing a real-time, interactive question-and-answer session broadcast to users via a global computer network.

In one embodiment of the present invention, a method of providing real-time question and answer sessions via a global computer network comprises providing a network-accessible data portal hosted on a central server, accessible to a plurality of clients in a global computer network; receiving at the central server, a multimedia data stream from a broadcast host; displaying the multimedia data stream to a plurality of clients, including at least a first client, via the network-accessible data portal; receiving responsive data from the first client; and presenting the responsive data to the broadcast host; wherein the multimedia data stream is presented to the plurality of clients in real-time.

In another embodiment of the present invention, a computer-readable medium, stored on a central server, having computer-executable instructions for performing a method, comprises enabling a network-accessible data portal hosted on a central server, accessible to a plurality of clients in a global computer network; receiving a multimedia data stream from a broadcast host; displaying the multimedia data stream to a plurality of clients, including at least a first client, via the network-accessible data portal; receiving responsive data from the first client; and presenting the responsive data to the broadcast host; wherein the multimedia data stream is presented to the plurality of clients in real-time.

In yet another embodiment of the present invention, a system for providing real-time question and answer sessions via a global computer network comprises a network-accessible data portal hosted on a central server, accessible to a plurality of clients in a global computer network; a multimedia data stream generated from a broadcast host, and presented to a plurality of clients, including a first client; and a responsive data generated from the first client, presented to the broadcast host; wherein the multimedia data stream is presented to the plurality of clients in real-time.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a system-level network diagram in accordance with one embodiment of the present invention;

FIG. 2 depicts a block diagram of a general computer system in accordance with another embodiment of the present invention; and

FIG. 3 depicts a graphical representation of data flow in a system in accordance with yet another embodiment of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the figures.

### DETAILED DESCRIPTION

Embodiments of the present invention generally relate to a real-time question-and-answer session broadcast over a global computer network. More specifically, embodiments of the present invention relate to a system of and method for executing a real-time, interactive question-and-answer session broadcast to users via a global computer network.

Generally, the methods disclosed herein are understood by embodiments of the present invention to occur in “real-time.” Real-time is known in the industry as near-instantaneous, subject to minor delays caused by network transmission and computer processing functions, and able to support various input and output data streams.

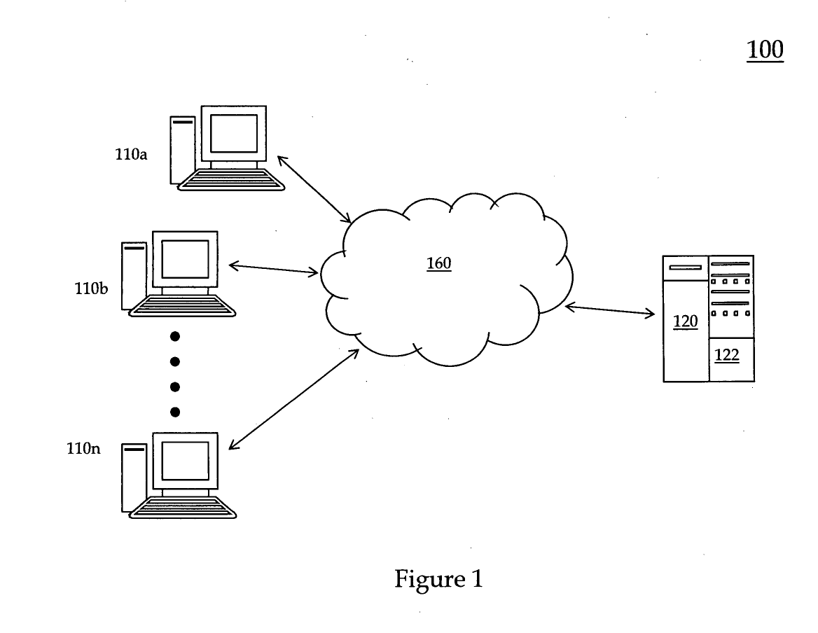

FIG. 1 depicts a block diagram of an exemplary system in accordance with one embodiment of the present invention. The system 100 generally includes at least a first customer 110a, also referred to herein as an end user or client. The system 100 may additionally include at least a second customer 110b, and additional customers, up to customer 110n, where n represents any number of customers practical for operation of embodiments of the present invention. The system 100 further comprises an administrator or host 120, i.e., an organization, company or individual who controls, designs and is generally responsible for implementing and/or facilitating each of the methods disclosed herein.

The network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G and 3G telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

The administrator 120 may comprise any person, business or entity capable of performing and administering the methods disclosed herein. In one embodiment, the administrator 120 is an entity hosting an accessible server and a database 122. The server may comprise any type of computing device suitable for embodiments of the present invention. The server may be located at the administrator 120 physical site or at a remote location accessible via the network 160.

The database 122 may include a number of records in accordance with embodiments of the present invention, including data and/or other information, which may be parsed and stored. The database 122 may further comprise software, which may include and/or employ one or more database management systems (“DBMS”), such as any one of an Oracle, DB2, Microsoft Access, Microsoft SQL Server, Postgres, MySQL, 4th Dimension, FileMaker and Alpha Five DBMS, and the like. The DBMS may be operable to query the database 122, parse the information into the records, execute rules for sorting the information parsed into the records, execute rules for performing operations (e.g., mathematical, statistical, logical, etc., operations) on the information parsed into the records, and the like.

In many embodiments, the database software may be operable to apply the data from records into one or more models to form one or more output records. These output records include information that may be used to facilitate the bartering methods as disclosed herein. In addition, the database software may be operable to interface with web-server software, to allow manipulation of the database 122 via one or more web pages available to the administrator 120 via the network 160.

Optionally, the system 100 may also comprise a third party financial institution 150. The financial institution 150 may comprise a bank, a credit-based company, or the like, suitable for facilitating the financial transactions within the system. In one embodiment, the financial institution comprises a web-based payment system, for example, PayPal®.

In accordance with many embodiments of the present invention, each of the parties associated with the system 100 comprise the necessary electronic devices, having platforms and databases where applicable, to execute the methods as set forth by embodiments of the present invention. Alternative system architectures are contemplated by embodiments of the present invention, provided such alternative architectures are capable of executing the various methods disclosed herein.

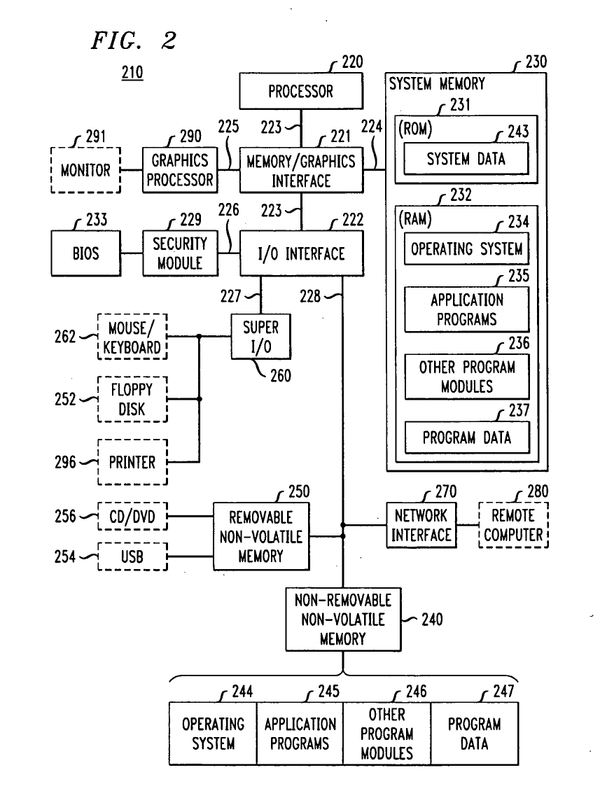

In several embodiments, the electronic device associated with each of the parties within the system comprises a general purpose computer system, for example, the general purpose computer system of FIG. 2. It should be appreciated, however, the general purpose computing system of FIG. 2 is merely an exemplary embodiment of an electronic device, and actual electronic devices may comprise any one or more components shown in FIG. 2, suitable for embodiments of the present invention.

With reference to FIG. 2, a general purpose computer system in the form of a computer 210 is shown. As understood by embodiments of the present invention, components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage metering, billing, and enforcement of policies.

A super input/output chip 260 may be used to connect to a number of ‘legacy’ peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

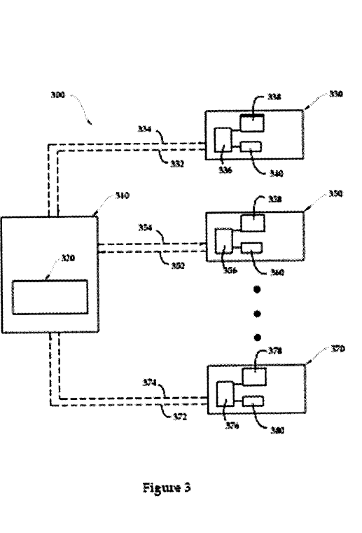

FIG. 3 depicts a graphical representation of data flow between an administrator and clients in a system in accordance with an exemplary embodiment of the present invention.

The system 300 is provided with a first client 330, a second client 350, a third client 370, and a server 310 hosting a network-accessible data portal (e.g., website). The first client 330 is provided with a client computer 336, an input device 338, and an output device 340. The input device 338 may be any device capable of producing a multimedia signal. For example, in one embodiment, the input device 338 is a webcam. Other exemplary input devices include microphone, keyboard, and the like. Similarly, the second client 350 and the third (or additional) client 370 are provided with respective client computers 356, 376, input devices 358, 378, and output devices 360, 380.

At the server 310, a “broadcast” may be presented by a host (i.e., the administrator or client, selected by the administrator to deliver the broadcast) through the network-accessible data portal 320. In some embodiments, the broadcast incorporates various multimedia formats (e.g., audio, video, and the like). For example, in one embodiment, the broadcast comprises an audio and a still video broadcast of information either created by the administrator or obtained from another source. In another embodiment, the broadcast incorporates a live video feed from a party, for example, the first client 330. Embodiments of the present invention contemplate any type of multimedia format supported by additional features of the embodiments of the present invention.

At the first client's computer 336, as the broadcast is being viewed and/or heard real-time by the first client 330 through data stream 334, the first client 330 may be able to provide feedback, ask questions, or similar data, through the input device 338 to the administrator at the server 310 via data stream 332. The second client 350 and third client 370 also receive the broadcast through a data stream 354, 374 in real-time. Similarly, through respective input devices 358, 378 feedback is capable of being provided during the broadcast through data streams 352, 372.

In one embodiment of the present invention, because of the nature of the flow of data, the broadcast is a question-and-answer session, viewable live in real-time over a global computer network. In such an embodiment, the clients 330, 350, 370 are able to access the network-accessible data portal 320 at any time during the broadcast. In another embodiment of the present invention, pre-registration may be required to access the live broadcast, and the registration information may be stored by the administrator at a database (not shown) on the server 310.

In accordance several embodiments of the present invention, the question-and-answer broadcast is interactive, i.e., there are no restrictive limitations on the flow of data. Throughout the course of a broadcast, clients are given the ability to submit questions to be answered by a host of the broadcast during select periods or durations of time. Optionally, clients submit questions during the broadcast by entering text into an electronic message box on the network-accessible data portal 320, and the questions are received solely by the host of the broadcast. Alternatively, clients submit questions to the host of the broadcast by utilizing a voice/audio recording mechanism to record a question/feedback verbally, and subsequently upload such feedback to the server 310.

In another embodiment of the present invention, clients submit questions to the host of the broadcast by granting the host visual access to the submitter's computer screen containing the content of the submission. Optionally, when a particular client's question is being addressed, the broadcast host may obtain full control of the particular client's computer which may be displayed to any number of clients monitoring the broadcast.

In certain embodiments, clients monitoring the broadcast may be permitted to submit questions/feedback concerning a predefined subject or set of subjects. For example, during a particular period of time, questions may only be submitted concerning one of economics, accounting, graphic design, computer literacy, word processing, computer programming, or any other feasible subject. In many other embodiments, the limitation of subject matter of the client submitted feedback may be defined by the subject matter of the broadcast.

In many embodiments of the present invention, questions received by the host of the broadcast are placed in a virtual queue for answering. In one embodiment of the present invention, submitted questions, in whatever format they have been received, are answered in the order in which they are received. In another embodiment of the present invention, a subscription fee may be paid to the administrator, in conjunction with creating a registration, to prioritize a client's question in the queue and/or advance its position in the queue.

In some embodiments of the present invention, the client who submitted the question to the host of the broadcast will receive an approximate waiting time representing the time between when the question was submitted and when the question should be answered by the host of the broadcast.

In some embodiments of the present invention, all clients within the system 300, participating or otherwise, can view questions in the queue. A client may able to view the quantity of questions in the queue, the content of the questions in the queue, or both the quantity and the content of the queued questions. In another embodiment of the present invention, certain clients who are actively participating in the broadcast can view the questions in the queue, while visiting clients cannot.

Optionally, the network-accessible data portal 320 may be established similar to a social network, whereby clients within the system 300 may be able to chat or message amongst each other, in a waiting room-type environment, as questions are pending in the queue.

In one embodiment of the present invention, the broadcast and associated feedback/questions during the broadcast are stored in a broadcast history for later viewing by all visitors, participating or otherwise, to the system 300. Additionally, in another embodiment of the present invention, a charge may be incurred by the visitor to the website for accessing the broadcast history.

In yet another embodiment, throughout the course of the broadcast, commercial messages are broadcast to viewers at various intervals. These messages can be commercial advertisements, public service announcements, or any other type of message feasible in the current context.

While the foregoing is directed to embodiments of the present invention, other and further embodiments of the invention may be devised without departing from the basic scope thereof.

What is claimed is:

1. A method of providing real-time question and answer sessions via a global computer network comprising:
providing a network-accessible data portal hosted on a central server, accessible to a plurality of clients in a global computer network;
receiving at the central server, a multimedia data stream from a broadcast host;
displaying the multimedia data stream to a plurality of clients, including at least a first client, via the network-accessible data portal;
receiving responsive data from the first client; and
presenting a summary of the responsive data to the broadcast host;
wherein the multimedia data stream is presented to the plurality of clients in real-time.

2. The method of claim 1, wherein the multimedia data stream comprises one of at least audio or visual data.

3. The method of claim 1, further comprising:
displaying the multimedia data stream to a second client; and
presenting the responsive data to the second client.

4. The method of claim 3, wherein presenting the responsive data to the second client occurs through the network-accessible data portal.

5. The method of claim 3, further comprising:
receiving additional responsive data from the second client; and
presenting the additional responsive data to the broadcast host and the first client.

6. The method of claim 1, wherein the responsive data comprises at least one of audio data, video data, text, or a combination thereof.

7. The method of claim 1, wherein a subject-matter of the multimedia data stream comprises at least one of economics, accounting, graphic design, computer literacy, word processing, or computer programming.

8. The method of claim 7, wherein the responsive data comprises subject matter substantially identical to the multimedia data stream.

9. A computer-readable medium, stored on a central server, having computer-executable instructions for performing a method, comprising:
enabling a network-accessible data portal hosted on a central server, accessible to a plurality of clients in a global computer network;
receiving a multimedia data stream from a broadcast host;
displaying the multimedia data stream to a plurality of clients, including at least a first client, via the network-accessible data portal;
receiving responsive data from the first client; and
presenting a summary of the responsive data to the broadcast host;
wherein the multimedia data stream is presented to the plurality of clients in real-time.

10. The computer-readable medium of claim 9, wherein the multimedia data stream comprises one of at least audio or visual data.

11. The computer-readable medium of claim 9, further comprising:
displaying the multimedia data stream to a second client; and
presenting the responsive data to the second client.

12. The computer-readable medium of claim 11, wherein presenting the responsive data to the second client occurs through the network-accessible data portal.

13. The computer-readable medium of claim 11, further comprising:
receiving additional responsive data from the second client; and
presenting the additional responsive data to the broadcast host and the first client.

14. The computer-readable medium of claim 9, wherein the responsive data comprises at least one of audio data, video data, text, or a combination thereof.

15. The computer-readable medium of claim 9, wherein a subject-matter of the multimedia data stream comprises at least one of economics, accounting, graphic design, computer literacy, word processing, or computer programming.

16. The computer-readable medium of claim 15, wherein the responsive data comprises subject matter substantially identical to the multimedia data stream.

17. A system for providing real-time question and answer sessions via a global computer network comprising:
a network-accessible data portal hosted on a central server, accessible to a plurality of clients in a global computer network;
a multimedia data stream generated from a broadcast host, and presented to a plurality of clients, including a first client;
a responsive data generated from the first client; and
a summary of the responsive data presented to the broadcast host;
wherein the multimedia data stream is presented to the plurality of clients in real-time.

18. The system of claim 17, further comprising additional responsive data generated from a second client, and presented to the broadcast host.

19. The system of claim 17, wherein the responsive data comprises at least one of audio data, video data, text, or a combination thereof.

20. The system of claim 17, wherein a subject-matter of the multimedia data stream comprises at least one of economics, accounting, graphic design, computer literacy, word processing, or computer programming.
